(19) United States
(12) Patent Application Publication
(10) Pub. No.: US 2026/0261001 A1
(43) Pub. Date: Sep. 3, 2026

(54) BATTERY WIRING MODULE

(71) Applicant: SUMITOMO WIRING SYSTEMS, LTD., Mie (JP)

(72) Inventor: Hiroshi SATO, Mie (JP)

(21) Appl. No.: 18/995,829

(22) PCT Filed: Jul. 13, 2023
(86) PCT No.: PCT/JP2023/025820

§ 371 Date: Jan. 17, 2025

(30) Foreign Application Priority Data
Aug. 1, 2022 (JP) 2022-122702

(51) Int. Cl. H01M 50/298; B60L 50/60; B60R 16/02; H01M 50/209; H01M 50/249

(52) U.S. Cl. CPC H01M 50/298; B60R 16/0215; H01M 50/209; H01M 50/249; B60L 50/60; H01M 2220/20

(57) ABSTRACT

A wire housing part (31) of a case of a battery wiring module (22) has a wire lead-out part (32) from which an electric wire bundle W is led out to the outside of the wire housing part (31). The electric wire bundle (W) has a curved part (Wa). The wire lead-out part (32) has an abutting part (41) that abuts against the curved part (Wa), and a fastening part (51) that fastens the curved part (Wa) to the abutting part (41). The abutting part (41) has a shape that matches the shape of the curved part (Wa).

### TECHNICAL FIELD

The present disclosure relates to a battery wiring module.

### BACKGROUND

As disclosed in Patent Document 1, for example, a battery wiring module is attached to a high-voltage battery that is mounted as a travelling power source in vehicles such as electric vehicles and hybrid vehicles. The battery wiring module includes a plurality of electric wires that are electrically connected to a battery, and a case that has a wire housing part for housing the electric wires. The wire housing part has a wire lead-out part for leading out an electric wire bundle, namely a bundle of a plurality of electric wires, to the outside of the wire housing part. The electric wire bundle may be fastened using a fastening band or the like in the wire lead-out part. In this case, the wire lead-out part has an abutting part against which the electric wire bundle is pressed by the fastening band or the like.

### PRIOR ART DOCUMENT

### Patent Document

Patent Document 1: JP 2021-190156 A

### SUMMARY OF THE INVENTION

### Problems to be Solved

When the electric wire bundle is disposed in a bent state in the wire lead-out part, a gap may occur between the electric wire bundle and the abutting part of the wire lead-out part. If a gap occurs between the electric wire bundle and the abutting part, the play in the electric wire bundle increases, which may reduce the stability of the fixation of the electric wire bundle using the fastening part.

The present disclosure aims to provide a battery wiring module capable of stably holding an electric wire bundle.

### Means to Solve the Problem

The battery wiring module of the present disclosure is a battery wiring module that is attachable to a battery, and includes: a plurality of electric wires to be electrically connected to the battery; and a case having a wire housing part housing the plurality of electric wires, wherein the wire housing part has a wire lead-out part from which an electric wire bundle being a bundle of the plurality of electric wires is led out to the outside of the wire housing part, the electric wire bundle has a curved part, the wire lead-out part has: an abutting part abutting against the curved part, and a fastening part fastening the curved part to the abutting part, and the abutting part has a shape that matches a shape of the curved part.

### Effect of the Invention

The battery wiring module of the present disclosure exhibits the effect of stably holding an electric wire bundle.

### BRIEF DESCRIPTION OF THE DRAWINGS

FIG. 1 is a schematic plan view of a battery wiring module of an embodiment.

FIG. 2 is a plan view of a portion of a case of the battery wiring module of the same embodiment.

FIG. 3 is a perspective view of a portion of the case of the battery wiring module of the same embodiment.

FIG. 4 is a plan view of a portion of the case of the battery wiring module of a modification.

### DETAILED DESCRIPTION TO EXECUTE THE INVENTION

### Description of Embodiments of Present Disclosure

Firstly, modes for carrying out the present disclosure are listed and described.
[1] The battery wiring module of the present disclosure is a battery wiring module that is attachable to a battery, and includes: a plurality of electric wires to be electrically connected to the battery; and a case having a wire housing part housing the plurality of electric wires, wherein the wire housing part has a wire lead-out part from which an electric wire bundle being a bundle of the plurality of electric wires is led out to the outside of the wire housing part, the electric wire bundle has a curved part, the wire lead-out part has: an abutting part abutting against the curved part, and a fastening part fastening the curved part to the abutting part, and the abutting part has a shape that matches a shape of the curved part.

According to this configuration, the abutting part, against which the curved part of the electric wire bundle is pressed by the fastening part, has a shape that matches the shape of the curved part. This can suppress the formation of a gap between the abutting part and the curved part. Accordingly, the electric wire bundle has less play around the curved part, and as a result, the abutting part and the fastening part can stably hold the electric wire bundle.
[2] In the above item [1], the abutting part may have a first rib and a second rib that are next to each other in an extension direction of the electric wire bundle, and the curved part may abut against a leading end of the first rib and a leading end of the second rib.

According to this configuration, the curved part of the electric wire bundle is pressed against the leading ends of the first and second ribs by the fastening part. Thus, the leading ends of the first and second ribs can stably hold the curved part, at least at two points.
[3] In the above item [2], the fastening part may be located in an intermediate area between the first rib and the second rib.

According to this configuration, the fastening force of the fastening part applied to the curved part of the electric wire bundle can be distributed in a balanced manner to the first and second ribs.
[4] In the above item [2] or [3], a length from a base end to the leading end of the first rib and a length from a base end to the leading end of the second rib may each be set to be a length that matches the shape of the curved part.

According to this configuration, the leading ends of the first and second ribs can abut against the curved part of the electric wire bundle.
[5] In the above item [4], the length of the first rib and the length of the second rib may be set to be different from each other.

According to this configuration, the leading ends of the first and second ribs can abut against the curved part of the electric wire bundle.
[6] In the above item [5], the first rib may be located on an outer side of the case relative to the second rib, and the length of the second rib may be greater than the length of the first rib.

According to this configuration, the leading ends of the first and second ribs can preferably abut against the curved part of the electric wire bundle.

### Details of Embodiments of the Present Disclosure

Specific examples of the battery wiring module of the present disclosure are described below with reference to the drawings. The drawings may partially exaggerate or simplify configurations for convenience of description. The dimensional ratio of each part may differ between the drawings.

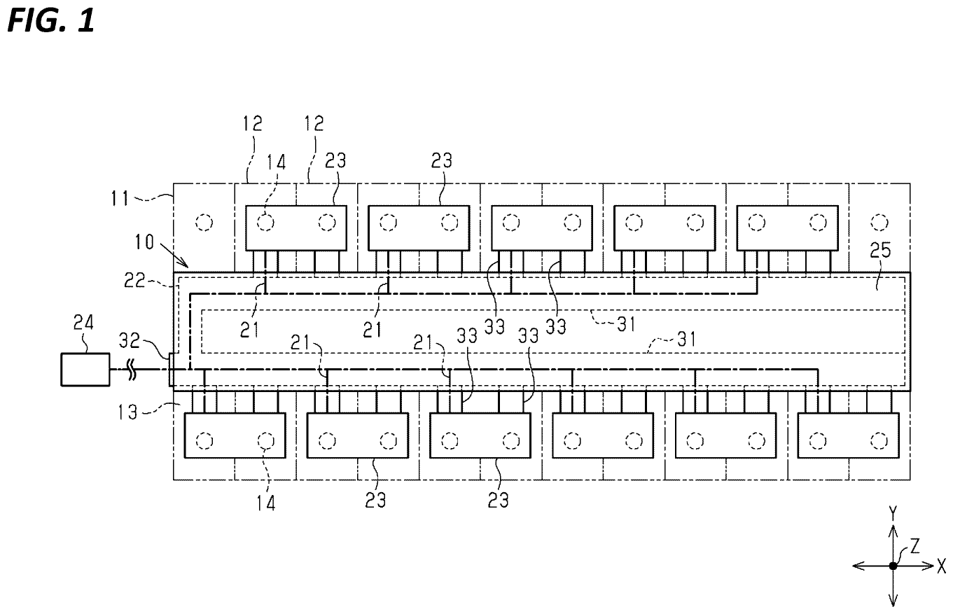

As shown in FIG. 1, a battery wiring module 10 of the present embodiment is configured, for example, to be attached to a battery 11 mounted in an electric vehicle, a hybrid vehicle, or the like. The battery 11 is, for example, a secondary battery. The battery 11 supplies electric power to a travel motor of a vehicle (not shown). Further, the battery 11 receives the supply of electric power from the travel motor and a power-generating motor in accordance with the state of charge and the driving state of the vehicle.

The battery 11 includes a plurality of battery cells 12. The battery 11 has, for example, a substantially rectangular-parallelepiped shape with the plurality of battery cells 12 arranged in rows in one direction. In the following description, the “X-direction” refers to the direction in which the battery cells 12 are arranged, and the “Y-direction” refers to the direction perpendicular to the X-direction. The “Z-direction”, which is orthogonal to the X-direction and the Y-direction, refers to the up-down direction. The term “above/upward/upper side” refers to the side from which the battery wiring module 10 is attached to the battery 11. That is, the battery 11 has a module attachment surface 13, which is an upper surface to which the battery wiring module 10 is attached.

Each battery cell 12 has two battery terminals 14. One of the two battery terminals 14 is a positive terminal, and the other one is a negative terminal. When the battery cells 12 are arranged in the X-direction, the two battery terminals 14 are arranged along the Y-direction on the upper surface of the battery cells 12.

### Configuration of Battery Wiring Module 10

The battery wiring module 10 includes a plurality of electric wires 21 that are electrically connected to the battery 11, and a case 22 for housing the electric wires 21. The battery wiring module 10 also includes a plurality of busbars 23, which are supported by the case 22, for example. The busbars 23 are located on both sides in the Y-direction of the case 22, and are arranged side by side along the X-direction. Each busbar 23 connects battery terminals 14 that are adjacent to each other in the X-direction. The busbars 23 are connected to the battery terminals 14 by welding, for example. Each busbar 23 is electrically connected to a corresponding electric wire 21. Each electric wire 21 is, for example, a detection wire for detecting the voltage of the corresponding busbar 23. Each electric wire 21 is connected to a connector 24 for connecting to a detection device (not shown). The battery wiring module 10 also includes a cover 25 that covers the upper side of the case 22.

### Configuration of Case 22

The case 22 is made of an insulating material, such as synthetic resin. The case 22 includes wire housing parts 31 in which the electric wires 21 are housed. The wire housing parts 31 extend in the X-direction. Two wire housing parts 31 are provided and arranged in the Y-direction. The two wire housing parts 31 merge on one end side in the X-direction, and a wire lead-out part 32 is located at this merging point. That is, the wire housing parts 31 have the wire lead-out part 32 at their ends in the lengthwise direction thereof. The wire lead-out part 32 is formed at one end in the X-direction of the case 22. The plurality of electric wires 21 are collectively led out to the outside of the case 22 from the wire lead-out part 32.

The case 22 has busbar holders 33 for holding the busbars 23. A plurality of busbar holders 33 are arranged in the X-direction. The busbar holders 33 extend outward in the Y-direction from the two wire housing parts 31. The busbar holders 33 arranged in the X-direction in two rows corresponding to the two wire housing parts 31. In the present embodiment, one busbar 23 is held by two busbar holders 33 adjacent to each other in the X-direction.

One end of each electric wire 21 is led from the wire housing part 31 to the busbar holder 33 side and connected to a corresponding busbar 23. The other end of each electric wire 21 is collectively led out from the wire lead-out part 32 to the outside of the case 22 and connected to the connector 24.

### Configuration of Curved Part Wa of Electric Wire Bundle W

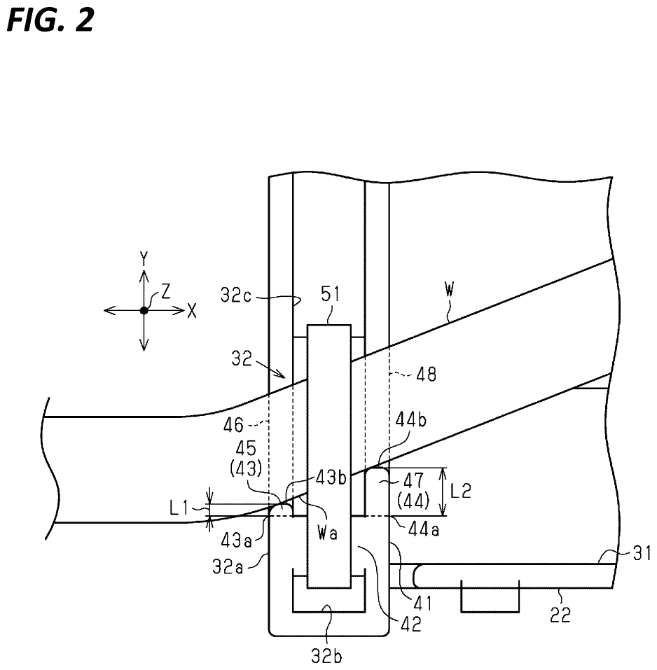

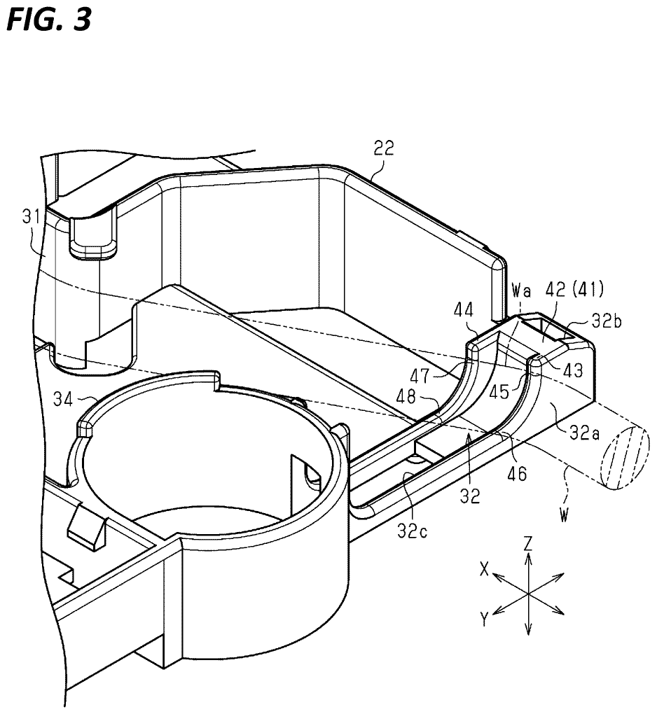

As shown in FIGS. 2 and 3, a plurality of electric wires 21 are bound together at a portion where they pass through the inside of the wire lead-out part 32, for example by an adhesive tape (not shown) wound around the outer periphery, to form an electric wire bundle W (see FIG. 2). The electric wire bundle W has a curved part Wa within the wire lead-out part 32. The curved part Wa is bent to curve along a plane perpendicular to the Z-direction, i.e., an XY plane.

As shown in FIG. 3, the case 22 has a protective wall 34 at an end in the X-direction on the side where the wire lead-out part 32 is located, for example. The protective wall 34 is located at a central portion in the Y-direction. The protective wall 34 surrounds a component (not shown) attached to the battery 11, for example.

The wire lead-out part 32 is next to the protective wall 34 in the Y-direction. In the case 22 of the present embodiment, the protective wall 34 is located at a central portion in the Y-direction, and the wire lead-out part 32 is accordingly located at a position shifted in the Y-direction from wire housing part 31. This does not allow the electric wire bundle W to be pulled out straight along the X-direction from the wire lead-out part 32. That is, the electric wire bundle W is bent so as to avoid the protective wall 34.

The curved part Wa of the electric wire bundle W is a portion that is bent in a region immediately before exiting from the wire lead-out part 32 to the outside of the case 22. The electric wire bundle W is pulled out along the X-direction from the wire lead-out part 32 in a region outside the case 22 due to being bent in the curved part Wa.

### Configuration of Wire Lead-Out Part 32

As shown in FIG. 2, the wire lead-out part 32 has an abutting part 41 and a fastening part 51. The abutting part 41 abuts against the outer peripheral surface of the curved part Wa. The fastening part 51 fixes the curved part Wa so as to fasten the curved part Wa to the abutting part 41. The fastening part 51 is, for example, a fastening band. The fastening part 51 is separate from the case 22, for example.

### Configuration of Abutting Part 41

As shown in FIGS. 2 and 3, the abutting part 41 has a shape that matches the shape of the curved part Wa. The abutting part 41 abuts against a portion of the curved part Wa on the outer side of the bent portion, for example. Note that the portion of the curved part Wa on the outer side of the bent portion refers to the protruding side of the curved part Wa when viewed from the Z-direction. The abutting part 41 has a base 42, a first rib 43, and a second rib 44. The first rib 43 and the second rib 44 protrude inward of the wire lead-out part 32 from the base 42.

The first rib 43 and the second rib 44 are next to each other along the extension direction of the electric wire bundle W. The first rib 43 and the second rib 44 are, for example, ribs that extend parallel with each other. The first rib 43 is located on the outer side of the case 22 relative to the second rib 44. The first rib 43 is located, for example, at a position that coincides with an outer surface 32a in the X-direction of the wire lead-out part 32. The second rib 44 is located on the inner side of the wire lead-out part 32 relative to the first rib 43.

As shown in FIG. 2, the first rib 43 has a base end 43a and a leading end 43b. The base end 43a of the first rib 43 is connected to the base 42. The second rib 44 has a base end 44a and a leading end 44b. The base end 44a of the second rib 44 is connected to the base 42.

The length from the base end 43a to the leading end 43b of the first rib 43 is denoted as a length L1. The length from the base end 44a to the leading end 44b of the second rib 44 is denoted as a length L2. The length L1 of the first rib 43 and the length L2 of the second rib 44 are set to be different so as to match the shape of the curved part Wa of the electric wire bundle W. In the present embodiment, the length L2 of the second rib 44 is set to be greater than the length L1 of the first rib 43 so as to match the shape of the curved part Wa. With this, the leading end 43b of the first rib 43 and the leading end 44b of the second rib 44 abut against the outer peripheral surface of the curved part Wa.

As shown in FIGS. 2 and 3, the first rib 43 includes a first portion 45 that protrudes in the Y-direction from the base 42, and a second portion 46 that protrudes in the Z-direction. The second rib 44 includes a third portion 47 that protrudes in the Y-direction from the base 42, and a fourth portion 48 that protrudes in the Z-direction. The length L2 of the second rib 44 gradually decreases from the third portion 47 toward the fourth portion 48. Meanwhile, the length L1 of the first rib 43 is constant from the first portion 45 toward the second portion 46. The leading end 43b of the first rib 43 that extends from the first portion 45 to the second portion 46 forms an arc-shape as viewed from the X-direction. The leading end 44b of the second rib 44 that extends from the third portion 47 to the fourth portion 48 forms an arc-shape as viewed from the X-direction.

The wire lead-out part 32 has a first through-hole 32b and a second through-hole 32c. The first through-hole 32b and the second through-hole 32c extend through the wire lead-out part 32 along the Z-direction. The abutting part 41 is located between the first through-hole 32b and the second through-hole 32c in the Y-direction.

As shown in FIG. 2, the fastening part 51 passes around the outer periphery of the curved part Wa of the electric wire bundle W while passing through the first through-hole 32b and the second through-hole 32c. The leading end of the fastening part 51 is inserted into and locked to a lock part (not shown) provided at the base end of the fastening part 51. The fastening part 51 thus fastens the curved part Wa to the abutting part 41. That is, the fastening part 51 presses the curved part Wa against the leading end 43b of the first rib 43 and the leading end 44b of the second rib 44. Thus, the leading end 43b of the first rib 43 and the leading end 44b of the second rib 44 come into intimate contact with the outer peripheral surface of the curved part Wa.

Note that the fastening part 51 is located between the first rib 43 and the second rib 44 as viewed from a direction (e.g., Z-direction) perpendicular to the extension direction of the electric wire bundle W. In other words, the first rib 43 and the second rib 44 are located on the respective sides of the fastening part 51 as viewed from the Z-direction. This allows the fastening force of the fastening part 51 to be distributed in a balanced manner to the first rib 43 and the second rib 44.

Effects of the present embodiment will be described.
(1) The wire lead-out part 32 has an abutting part 41 that abuts against the curved part Wa, and a fastening part 51 that fastens the curved part Wa to the abutting part 41. The abutting part 41 has a shape that matches the shape of the curved part Wa. According to this configuration, the abutting part 41, against which the curved part Wa of the electric wire bundle W is pressed by the fastening part 51, has a shape that matches the shape of the curved part Wa. This can suppress the formation of a gap between the abutting part 41 and the curved part Wa. Accordingly, the electric wire bundle W has less play around the curved part Wa, and as a result, the abutting part 41 and the fastening part 51 can stably hold the electric wire bundle W.
(2) The abutting part 41 has a first rib 43 and a second rib 44 that are next to each other along the extension direction of the electric wire bundle W. The curved part Wa abuts against the leading end 43b of the first rib 43 and the leading end 44b of the second rib 44. According to this configuration, the curved part Wa of the electric wire bundle W is pressed against the leading end 43b of the first rib 43 and the leading end 44b of the second rib 44 by the fastening part 51. Thus, the leading end 43b of the first rib 43 and the leading end 44b of the second rib 44 can stably hold the curved part Wa, at least at two points.
(3) The fastening part 51 is located in an intermediate area between the first rib 43 and the second rib 44. According to this configuration, the fastening force of the fastening part 51 applied to the curved part Wa of the electric wire bundle W can be distributed in a balanced manner to the first rib 43 and the second rib 44.
(4) The length L1 of the first rib 43 and the length L2 of the second rib 44 are set to be different so as to match the shape of the curved part Wa. According to this configuration, the leading end 43b of the first rib 43 and the leading end 44b of the second rib 44 can abut against the curved part Wa of the electric wire bundle W.
(5) The length L1 from the base end 43a to the leading end 43b of the first rib 43 and the length L2 from the base end 44a to the leading end 44b of the second rib 44 are set to be different. According to this configuration, the leading end 43b of the first rib 43 and the leading end 44b of the second rib 44 can abut against the curved part Wa of the electric wire bundle W.
(6) The first rib 43 is located on the outer side of the case 22 relative to the second rib 44. In addition, the length L2 of the second rib 44 is greater than the length L1 of the first rib 43. Here, if the length L2 of the second rib 44 is equal to or smaller than the length L1 of the first rib 43, the third portion 47 of the second rib 44 will be separated from the curved part Wa. In this regard, in the present embodiment, the length L2 of the second rib 44 is set to be greater than the length L1 of the first rib 43, allowing the third portion 47 of the second rib 44 to come into intimate contact with the outer peripheral surface of the curved part Wa. Accordingly, the first rib 43, the second rib 44, and the fastening part 51 can preferably hold the electric wire bundle W.

### Modifications

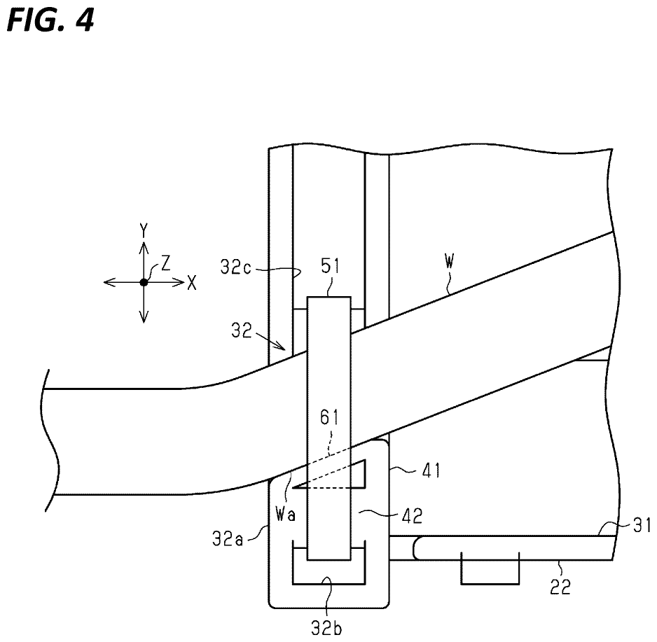

The present embodiment can be modified as follows when implemented. The above embodiment and the following modifications can be implemented in combination as long as no technical contradiction arises.
In the above embodiment, the leading end 43b of the first rib 43 and the leading end 44b of the second rib 44 included in the abutting part 41 abut against the curved part Wa of the electric wire bundle W. However, there is no limitation thereto. For example, the abutting part 41 may alternatively have one intimate contact surface 61 having a shape that matches the shape of the curved part Wa, as shown in FIG. 4. According to this configuration, the fastening part 51 presses the curved part Wa of the electric wire bundle W against the intimate contact surface 61 having a shape that matches the shape of the curved part Wa. This can suppress the formation of a gap between the intimate contact surface 61 and the curved part Wa. Accordingly, the electric wire bundle W has less play around the curved part Wa, and as a result, the intimate contact surface 61 and the fastening part 51 can stably hold the electric wire bundle W.
The fastening part 51 may be integrated with the case 22.
The first rib 43 may be located inward of the outer surface 32a of the wire lead-out part 32.
The abutting part 41 of the above embodiment has two ribs that abut against the curved part Wa, namely the first rib 43 and the second rib 44. However, there is no limitation thereto, and the number of ribs may be one, or three or more.
The abutting part 41 may be configured to abut against a portion of the curved part Wa on the inner side of the bent portion. Note that the portion of the curved part Wa on the inner side of the bent portion refers to the recessed side of the curved part Wa when viewed from the Z-direction. In the case of the abutting part 41 configured to abut against a portion of the curved part Wa on the inner side of the bent portion, the length L1 of the first rib 43 may be greater than the length L2 of the second rib 44. With this, the leading end 43b of the first rib 43 and the leading end 44b of the second rib 44 can come into intimate contact with the outer peripheral surface of the curved part Wa of the electric wire bundle W.
The embodiment and the modifications disclosed herein are illustrative in all respects, and should not be considered restrictive. That is, the scope of the present invention is defined by the claims, and is intended to encompass all modifications within the meaning and scope equivalent to the claims.

### LIST OF REFERENCE NUMERALS

10 Battery wiring module

11 Battery

12 Battery cell

13 Module attachment surface

14 Battery terminal

21 Electric wire

22 Case

23 Busbar

24 Connector

25 Cover

31 Wire housing part

32 Wire lead-out part

32a Outer surface

32b First through-hole

32c Second through-hole

33 Busbar holder

34 Protective wall

41 Abutting part

42 Base

43 First rib

43a Base end

43b Leading end

44 Second rib

44a Base end

44b Leading end

45 First portion

46 Second portion

47 Third portion

48 Fourth portion

51 Fastening part

61 Intimate contact surface

L1 Length of first rib

L2 Length of second rib

W Electric wire bundle

Wa Curved part

1. A battery wiring module that is attachable to a battery, the battery wiring module comprising:
a plurality of electric wires to be electrically connected to the battery; and
a case having a wire housing part housing the plurality of electric wires,
wherein the wire housing part has a wire lead-out part from which an electric wire bundle being a bundle of the plurality of electric wires is led out to the outside of the wire housing part,
the electric wire bundle has a curved part,
the wire lead-out part has: an abutting part abutting against the curved part, and a fastening part fastening the curved part to the abutting part, and
the abutting part has a shape that matches a shape of the curved part.

2. The battery wiring module according to claim 1,
wherein the abutting part has a first rib and a second rib that are next to each other in an extension direction of the electric wire bundle, and
the curved part abuts against a leading end of the first rib and a leading end of the second rib

3. The battery wiring module according to claim 2,
wherein the fastening part is located in an intermediate area between the first rib and the second rib.

4. The battery wiring module according to claim 2,
wherein a length from a base end to the leading end of the first rib and a length from a base end to the leading end of the second rib are each set to be a length that matches the shape of the curved part.

5. The battery wiring module according to claim 4,
wherein the length of the first rib and the length of the second rib are set to be different from each other.

6. The battery wiring module according to claim 5,
wherein the first rib is located on an outer side of the case relative to the second rib, and
the length of the second rib is greater than the length of the first rib.
